(19) United States
(12) Patent Application Publication
(10) Pub. No.: US 2011/0179929 A1
(43) Pub. Date: Jul. 28, 2011

(54) MANUAL CUTTING APPARATUS

(76) Inventor: Felipe Angel, Laguna Hills, CA (US)

(21) Appl. No.: 12/691,890

(22) Filed: Jan. 22, 2010

(51) Int. Cl. B26D 5/10

(52) U.S. Cl. 83/614

(57) ABSTRACT

A manual cutting apparatus for cutting thick media includes a sliding blade housed within a carriage. The sliding blade is adjustable in cutting depth to enable scoring and cutting all the way through. The carriage rides on a pair of rails. To operate, the user presses down on an actuator to lower the cutting blade and then slides the cutting mechanism from a starting end to a finishing end, namely, toward the user's body. A securing mechanism fixes the media in place and thereby frees the user's other hand from having to hold the media. The user's other hand may grab onto a leverage handle adjacent to the starting end of the base for extra leverage in sliding the cutting mechanism with the first hand.

### BACKGROUND OF THE INVENTION

1. Field of the Invention

The present invention relates generally to a manual cutting apparatus.

2. Description of Prior Art and Related Information

While various cutting machines exist for thin paper, a need still exists for a safe and effective way to cut thick media manually. The conventional way of manually cutting thick media such as chipboards consists of the age old method of marking with a ruler and then cutting with a box cutter or knife. Such imprecise cutting techniques can lead to less than straight edges. Also, using exposed blades can be hazardous.

The growing scrapbook and arts-and-crafts industries is creating a great demand for do-it-yourself projects and the tools that enable such hobbyists to accomplish those projects. Since thick media can be difficult and dangerous to cut, projects involving customized thick media have been limited.

Accordingly, a great demand exists for the appropriate tools to enable individuals to cut thick media properly and safely.

### SUMMARY OF THE INVENTION

The present invention provides structures and methods which overcome the deficiencies in the prior art.

In one aspect, a manual cutting apparatus is provided. The apparatus comprises a sliding blade being adjustable in cutting depth, an actuator to cause the blade to contact media, and a base for supporting the media. The base has a first end and a second opposite end configured to support an edge of the media. The blade is movable from a starting position adjacent to the first end of the base to a finishing position adjacent to the second end of the base. A handle is disposed adjacent to the first end and configured to receive the other hand not moving the blade. The blade is adjustable between metered heights.

The apparatus further comprises an adjustment handle to adjust the cutting depth of the blade. A vertically movable securing mechanism, such as a clampdown bar, is configured to fix the media in place. An enclosure surrounds the blade and prevents access to the blade except for the media. The blade may be replaceable. The actuator comprises a pivotable actuator handle.

In another aspect, a manual cutting apparatus comprises a base for supporting a media. The base has a first end and a second opposite end configured to support an edge of the media. An axially sliding blade is adjustable in cutting depth. The blade is movable from a starting position adjacent to the first end of the base to a finishing position adjacent to the second end of the base. An actuator causes the blade to descend and contact the media.

A handle is disposed adjacent to the first end and configured to receive a hand not moving the blade. The blade is adjustable between metered depths. The apparatus further comprises an adjustment handle to adjust the cutting depth of the blade.

The apparatus further comprises a vertically movable pressure bar to fix the media in place. An enclosure surrounds the blade and prevents access to the blade except for the media. The blade is replaceable. The actuator comprises a pivotable actuator handle.

In a further aspect, a manual cutting apparatus comprises a sliding blade being adjustable in cutting depth, and an actuator to cause the blade to contact media. A base for supporting the media has a first end and a second opposite end configured to support an edge of the media. A handle is disposed adjacent to the first end and configured to receive a hand not moving the blade. The blade is movable from a starting position adjacent to the first end of the base to a finishing position adjacent to the second end of the base. The blade is adjustable between metered heights.

The apparatus further comprises an adjustment handle to adjust the cutting depth of the blade. The apparatus further comprises a vertically movable pressure bar to fix the media in place. An enclosure surrounds the blade and prevents access to the blade except for the media. The blade is replaceable. The actuator comprises a pivotable actuator handle.

In another aspect, a manual cutting apparatus for cutting thick media includes a sliding blade housed within a carriage. The sliding blade is adjustable in cutting depth to enable scoring and cutting all the way through. The carriage rides on a pair of rails. To operate, the user presses down on an actuator to lower the cutting blade and then slides the cutting mechanism from a starting end to a finishing end, namely, toward the user's body. A securing mechanism fixes the media in place and thereby frees the user's other hand from having to hold the media. The user's other hand may grab onto a leverage handle adjacent to the starting end of the base for extra leverage in sliding the cutting mechanism with the first hand.

The invention, now having been briefly summarized, may be better appreciated by the following detailed description.

### BRIEF DESCRIPTION OF THE DRAWINGS

FIG. 1 is a perspective view of a preferred embodiment of a manual cutting apparatus;

FIG. 2A is a side cutaway view illustrating the preferred cutting mechanism in an upper, default rest position;

FIG. 2B is a side cutaway view illustrating the preferred cutting mechanism in a first cutting depth corresponding to a first adjustment setting;

FIG. 2C is a side cutaway view illustrating the preferred cutting mechanism in a second cutting depth corresponding to a second adjustment setting;

FIG. 2D is a side cutaway view illustrating the preferred cutting mechanism in a third cutting depth corresponding to a third adjustment setting;

FIG. 2E is a side cutaway view illustrating the preferred cutting mechanism in a fourth cutting depth corresponding to a fourth adjustment setting;

FIG. 3 is a perspective, operative view of the preferred cutting apparatus;

FIG. 4 is a close-up perspective view of the preferred cutting apparatus illustrating a preferred securing mechanism in a default position;

FIG. 5 is a close-up perspective view of the preferred cutting apparatus illustrating the preferred securing mechanism in a locked, securing position; and

FIG. 6 is a diagram of a preferred method of manually cutting thick media.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

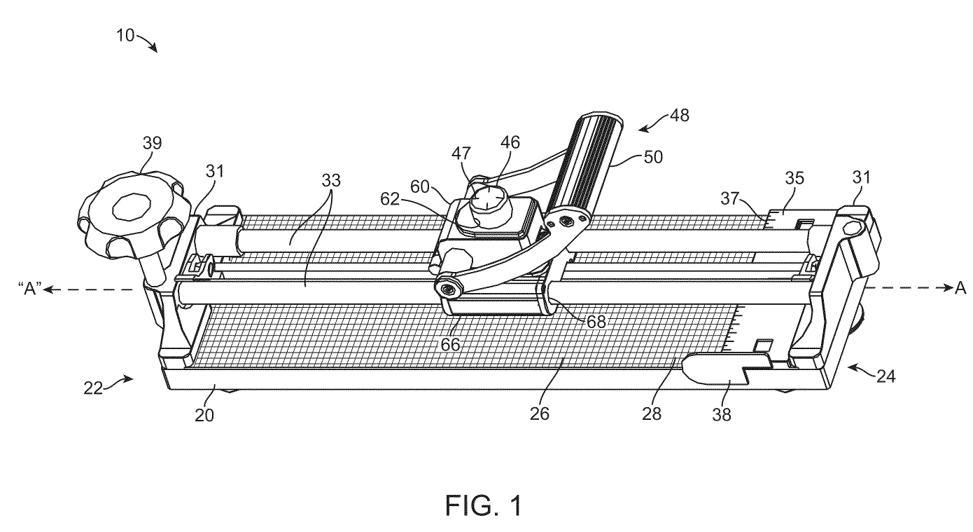

FIG. 1 is a perspective view of a preferred embodiment of a manual cutting apparatus 10. The apparatus 10 is preferably adapted for individuals to manually cut and/or score thick media, such as chipboards, clipboards, canvas art boards, thick cardstock, foam boards, corrugated cardboards, and other such thick materials. As discussed further below, the relatively small size of the apparatus 10 makes it easily portable and convenient for storing or transporting to a desired location.

The apparatus 10 comprises a base 20 having a first end 22 and an opposite second end 24. A top surface 26 may include markings 28, for example, in the form of a grid, to facilitate alignment of media to be cut. The base 20 may comprise a top veneer which forms the top surface 26. A pair of brackets 31 are mounted on top of the base 20 adjacent the first end 22 and second end 24 and configured to support one or more rails 33 to facilitate sliding of a preferred cutting mechanism as discussed further below.

In the preferred embodiment, a guide 35 generally comprising a plate with ruler markings is disposed on the base 20 adjacent to the second end 24. The guide 35 provides a resting edge 37 that is substantially perpendicular to an axis “A” defined by the cutting mechanism, and is adapted for abutting and/or aligning the media to be cut. The guide 35 may also include a lateral stop 38 that is laterally adjustable. A leverage handle 39 is disposed adjacent to first base end 22 and adapted for gripping by the user with the free hand which is not operating the cutter mechanism.

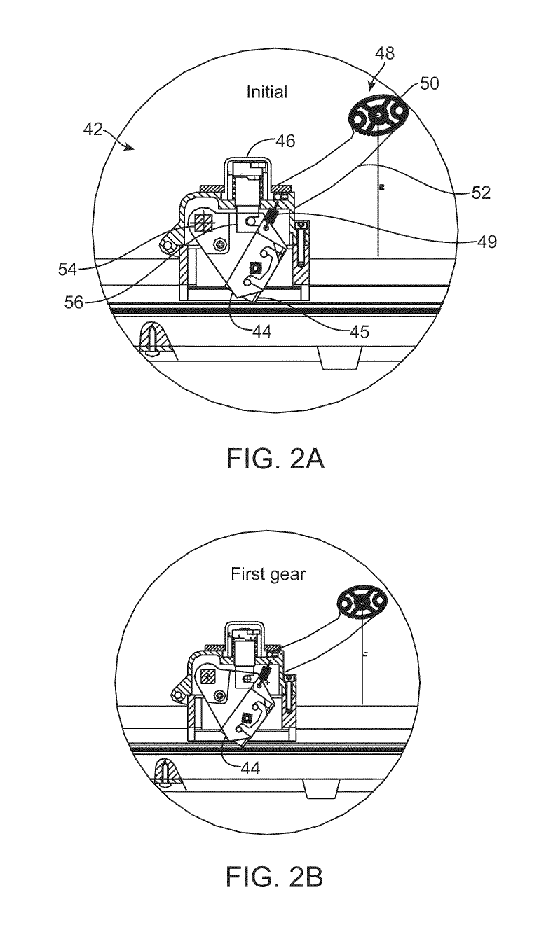

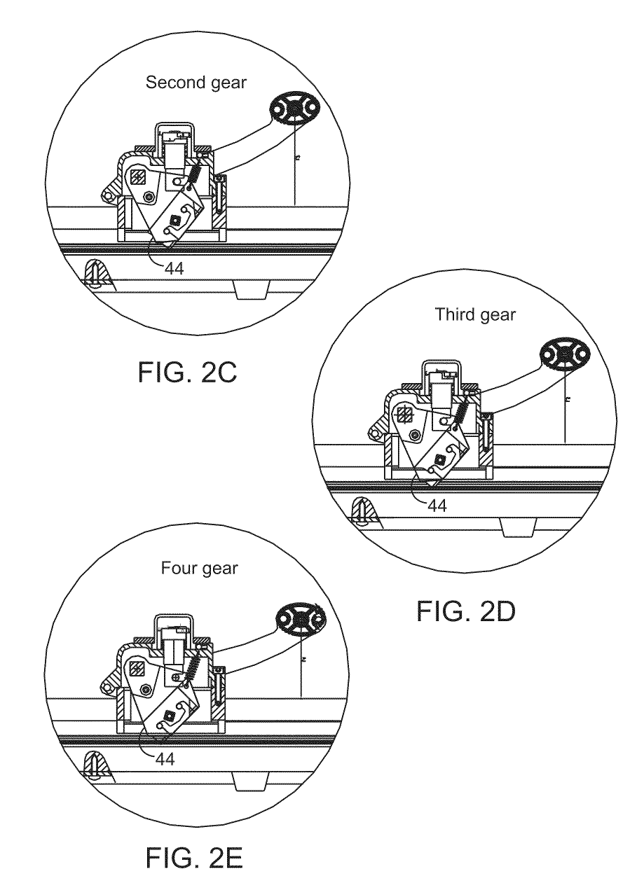

FIGS. 2A is cross-sectional view of the preferred cutting mechanism 42 at an uppermost default position. The cutting mechanism 42 comprises a blade 44 that is adjustable in height and, thus, vertical cutting depth when actuated. The blade 44 comprises a cutting edge or point 45. A rotatable knob 46 is coupled to the blade 44 and configured to enable a user to adjust the cutting depth of the blade 44. In the preferred embodiment as shown in FIG. 1, the knob 46 has markings 47 corresponding to metered cutting positions, or cutting depths, of the blade 44. In the illustrated embodiment shown in FIGS. 2A-E, the knob 46 and blade 44 are configured to provide a number of predetermined heights (e.g., 1 mm, 2 mm, 3 mm and 4 mm), with the knob 46 set to click or lock in position at each one of the metered settings.

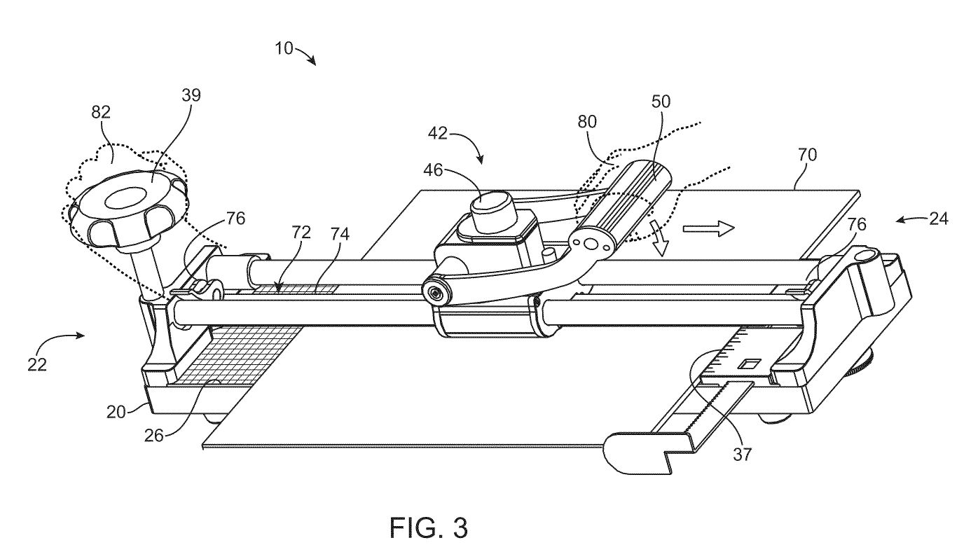

An actuator 48 causes the blade 44 to descend to its full cutting depth and come into operative contact with the media. The actuator 48 is biased towards an upward default position, such as with a spring 49, so as to lift and maintain the blade 44 in a non-operative position as shown in FIG. 2. In the preferred embodiment, the actuator 48 comprises an actuator handle 50 coupled to a yoke 52 which, when pressed downward, rotates an axle or pivot bar 54, thereby causing downward translation and rotation of the blade 44 to its cutting position as shown in FIG. 3.

A plurality of gears couple the actuator 48 to the blade 44, and cause downward movement of the actuator 48 to rotatably lower the blade 44 into cutting position. In FIG. 2, a vertically movable shaft 56 having a slot 58 is connected to the pivot bar 54. Through a series of gears and/or other intermediate connectors, downward force on the actuator 48 correspondingly moves the shaft 56 downward, thereby moving the pivot bar 54 downward. This in turn rotates and lowers the blade 44 into cutting position. The knob 46 limits the depth to which the shaft 56 can descend, thereby providing a vertical stop and thus a fixed depth for the blade 44.

FIGS. 2B to 2E illustrate the blade 44 descended into cutting position as adjusted by the knob, with 2B being the most shallow (e.g., preferable for scoring lines on media) and 2E being the deepest. FIG. 2B illustrates the blade 44 descending into a shallow cutting position when fully actuated as dictated by the adjustment knob 46. Thus, the position shown in FIG. 2B as well as FIG. 2C may be appropriate for scoring lines on thick media without cutting the media all the way through.

FIGS. 2D and 2E illustrate a third and fourth cutting position, respectively, as dictated by the adjustment knob 46. The third and fourth cutting positions may be appropriate for cutting media all the way through. As examples and not by way of limitation, the cutting positions may range from 1 mm to 5 mm above the base. Furthermore, fewer or greater settings may be provided.

In the preferred embodiment, it will be appreciated FIGS. 2B to 2E illustrate metered, or incremental, depths (or heights with respect to the base) as predetermined and set by the adjustment knob. Alternatively, the adjustment knob and blade may be configured to descend to continuous, as opposed to incremental, depths.

Referring back to FIG. 1, the blade is generally enclosed within a housing, or carriage, 60 having a top opening 62 through which the actuator knob 46 is disposed and a bottom opening 64 through which the blade 44 may be vertically translated when actuated. The housing 60 is supported by a movable carrier 66 which is slidably coupled to the rails 33. In the preferred embodiment which includes a pair of rails 33, the carrier 66 defines a pair of openings or passageways 68 sized to receive the rails 33 while enabling free movement of the carrier 55. Thus, the housing 60 and carrier 66 collectively shield the blade 44 and safely prevent the user's hands from being harmed by the blade 44. A top of the housing 60 is removable in order to provide access to the cutting blade 44, which may be replaced with a new blade.

FIG. 3 is an operative view of the cutting apparatus 10. A generally thick media 70, such as chipboard, is placed on the top surface 26 of the base 20 and rested against the plate edge 37. A securing mechanism 72 enables the user to fix the media in position, thereby freeing the user to operate the cutting mechanism 42 with one hand 80, and hold the leverage handle 39 with the other hand 82 for greater leverage in moving the cutting mechanism 42. This will be appreciated particularly when scoring or cutting thick media.

To operate the cutting mechanism, the cutting mechanism is initially positioned adjacent to the first starting end 22. One hand 80 first pushes down on the cutter handle 50 preferably until it stops (i.e., deepest cutting position as set by the adjustment know 46) and then, while holding the cutter handle 50 at its lowermost position, slides the cutting mechanism 42 from the first, starting end 22 to the second, finish end, 24. The apparatus 10 is configured such that the user's body is located adjacent to the finish end 24. Accordingly, the user slides the cutting mechanism 42 from the starting end, which is farther from the user body, toward himself or herself.

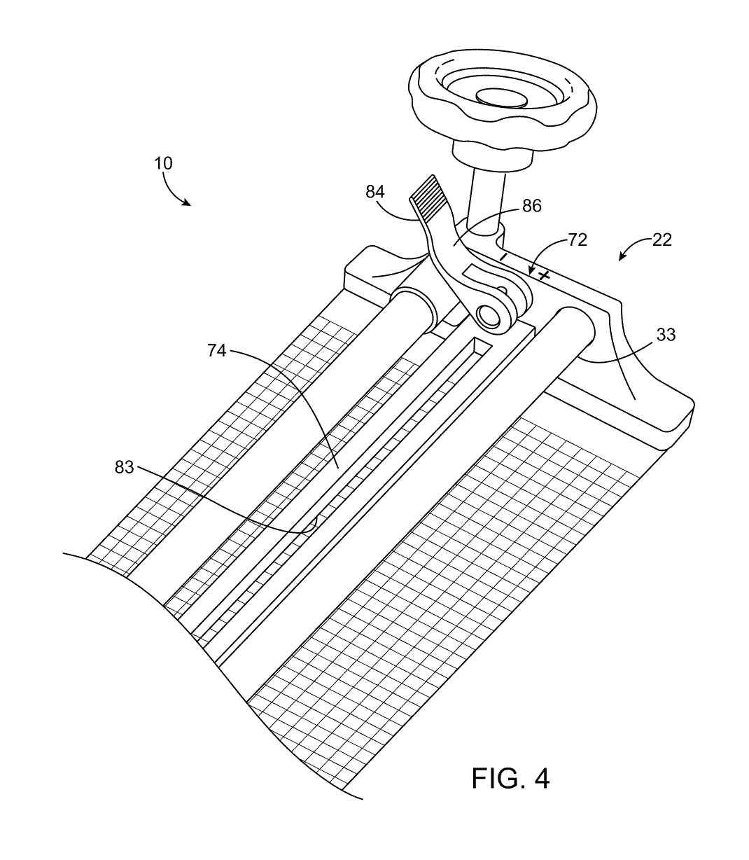

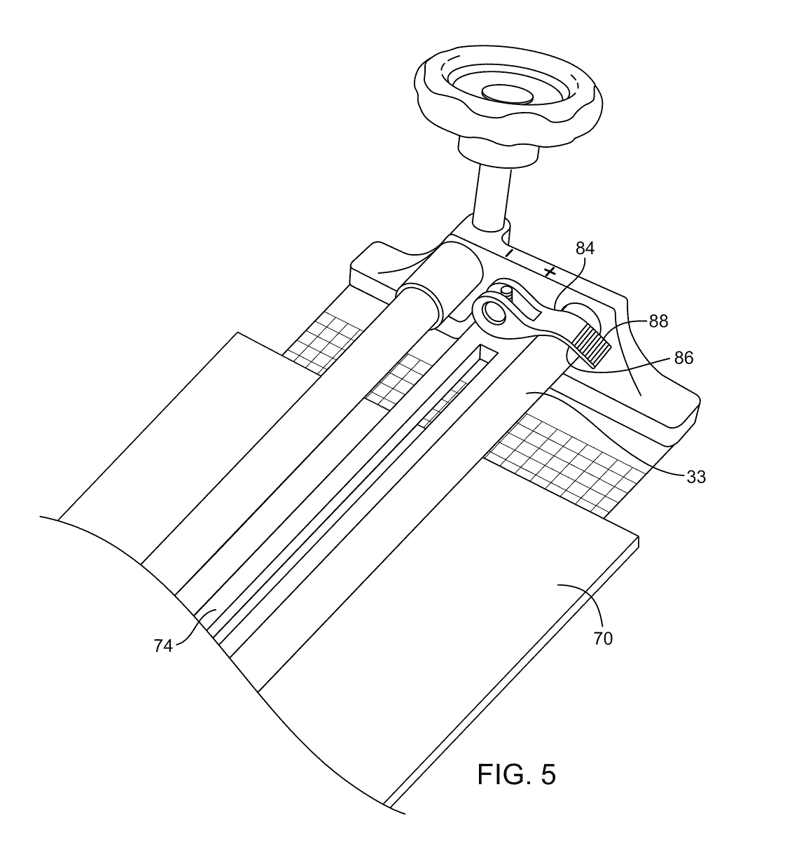

In the preferred embodiment as shown in FIG. 4, the securing mechanism 72 comprises a clampdown pressure bar 74 which is biased upwardly (e.g., spring biased) to an open, default position. This upward, open position, may be preconfigured to provide a gap sufficiently large to accommodate a maximum thickness of media to be cut. The clampdown bar may comprise an axial slot 83 to enable the cutting blade, shown in FIGS. 2A-E, to pass through and engage the media.

The securing mechanism 72 comprises a rotatable lever 84 having a cam surface 86 which lowers the clampdown bar 74 when the lever 84 is moved to a closed, locked position as shown in FIG. 5. The lever 84 is preferably located adjacent to the first, starting end 22 of the apparatus 10 so as not to get in the way when the cutting mechanism is being slid towards the opposite, finishing end. The lever 84 may also comprise a curve 86 configured to accommodate the rail 33 over which the lever 84 rests when locked in position as shown in FIG. 5. The curve 86 also serves to suggest to the user to rotate the lever 84 as much as possible toward the rail 33 shown to the right in order to secure the media. Etchings 88 may be provided on opposites surfaces near a tip of the lever 84 to facilitate gripping.

Once the lever 84 is fully rotated, the clampdown bar 74 is locked in position, thereby securely fixing the media in place to be cut. As a result, the user's hands are freed from having to hold the media. Accordingly, one hand may grip the leverage handle for extra leverage while the other hand operates the cutting mechanism as shown in FIG. 3. Holding the leverage handle with the second hand is particularly advantageous when greater strength is required of the first hand to actuate and slide the cutting mechanism in order to cut thick media, such as chipboards, book covers, stacks of paper, cardboard, etc.

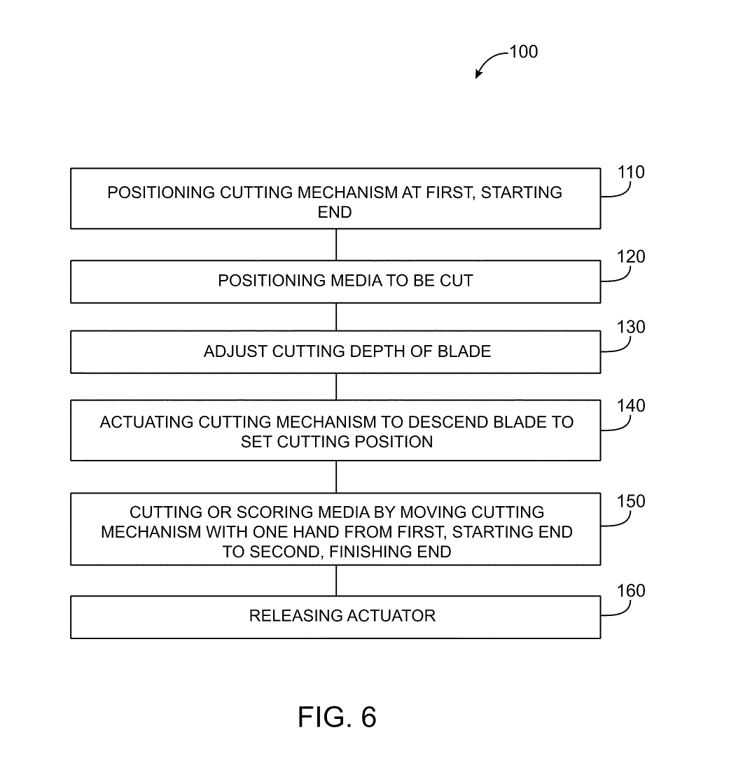

In FIG. 6, a preferred method 100 of manually cutting thick media is provided according to the invention. In step 110, the cutting mechanism is initially positioned adjacent the first, starting end 22 of the base 20 which is farthest away from the user's body. In step 120, the media 65 is positioned against the guide and fixed by the securing mechanism which may comprise a clampdown bar. In step 130, the appropriate cutting depth setting is selected by adjusting the actuator knob. In step 140, the user then presses down on the actuator and holds it down while, in step 150, moving the actuator 48 from its starting position adjacent the first base end 22 to a finish position adjacent the second base end 24. Step 150 thus comprises the user sliding the cutting mechanism toward himself or herself while holding down the actuator.

Depending upon the cutting depth selected, step 150 may comprise scoring the media or cutting it all the way through. Step 150 may also comprise moving the cutting mechanism from the starting end to the finishing end using only one hand. The other hand need not hold the media in place, but rather may grip the leverage knob adjacent the starting end for leverage in sliding the cutting mechanism.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A manual cutting apparatus, comprising:
a sliding blade being adjustable in cutting depth;
an actuator to cause the blade to contact media;
a base for supporting the media.

2. The apparatus of claim 1, wherein:
the base has a first end and a second opposite end configured to support an edge of the media; and
the blade is movable from a starting position adjacent to the first end of the base to a finishing position adjacent to the second end of the base.

3. The apparatus of claim 2, further comprising:
a handle disposed adjacent to the first end and configured to receive a hand not moving the blade.

4. The apparatus of claim 1, wherein the blade is adjustable between metered depths.

5. The apparatus of claim 1, further comprising:
an adjustment handle to adjust the cutting depth of the blade.

6. The apparatus of claim 1, further comprising:
a vertically movable pressure bar to fix the media in place.

7. The apparatus of claim 1, further comprising an enclosure surrounding the blade and preventing access to the blade except for the media.

8. The apparatus of claim 1, wherein the blade is replaceable.

9. The apparatus of claim 1, wherein the actuator comprises a pivotable actuator handle.

10. A manual cutting apparatus, comprising:
a base for supporting a media, the base having a first end and a second opposite end configured to support an edge of the media;
a sliding blade being adjustable in cutting depth, the blade being movable from a starting position adjacent to the first end of the base to a finishing position adjacent to the second end of the base; and
an actuator to cause the blade to contact media.

11. The apparatus of claim 10, further comprising:
a handle disposed adjacent to the first end and configured to receive a hand not moving the blade.

12. The apparatus of claim 10, wherein the blade is adjustable between metered heights.

13. The apparatus of claim 10, further comprising:
an adjustment handle to adjust the cutting depth of the blade.

14. The apparatus of claim 10, further comprising:
a vertically movable pressure bar to fix the media in place.

15. The apparatus of claim 10, further comprising an enclosure surrounding the blade and preventing access to the blade except for the media.

16. The apparatus of claim 10, wherein the blade is replaceable.

17. The apparatus of claim 10, wherein the actuator comprises a pivotable actuator handle.

18. A manual cutting apparatus, comprising:
a sliding blade being adjustable in cutting depth;
an actuator to cause the blade to contact media;
a base for supporting the media, the base having a first end and a second opposite end configured to support an edge of the media; and
a handle disposed adjacent to the first end and configured to receive a hand not moving the blade.

19. The apparatus of claim 18, wherein:
the blade is movable from a starting position adjacent to the first end of the base to a finishing position adjacent to the second end of the base.

20. The apparatus of claim 18, wherein the blade is adjustable between metered heights.

21. The apparatus of claim 18, further comprising:
an adjustment handle to adjust the cutting depth of the blade.

22. The apparatus of claim 18, further comprising:
a vertically movable pressure bar to fix the media in place.

23. The apparatus of claim 18, further comprising an enclosure surrounding the blade and preventing access to the blade except for the media.

24. The apparatus of claim 18, wherein the blade is replaceable.

25. The apparatus of claim 18, wherein the actuator comprises a pivotable actuator handle.
